(19) United States
(12) Patent Application Publication
(10) Pub. No.: US 2009/0313337 A1
(43) Pub. Date: Dec. 17, 2009

(54) Method for Generating Extended Information

(75) Inventors: Xiaofeng Jin, Cupertino, CA (US); Ka Man Mark Tong, Richardson, TX (US)

Correspondence Address: Xiaofeng Jin, 3 Results Way, Cupertino, CA, 95014, US

(73) Assignee: LINKOOL INTERNATIONAL, INC., Cupertino, CA (US)

(21) Appl. No.: 12/204,812

(22) Filed: Sep. 5, 2008

Related U.S. Application Data
(63) Continuation-in-part of application No. 12/136,780, filed on Jun. 11, 2008, now abandoned.

(51) Int. Cl. G06F 15/16; G06F 17/30; G06F 17/00; G06F 3/048

(52) U.S. Cl. 709/206; 707/102; 715/234; 715/780

(57) ABSTRACT

A method for displaying a set of results in a client system comprises first sending an information request having at least a word string to a server system. The server system then selects an application service, which provides a set of results. The server system then transmits an information package corresponding to the application service. Finally, the client system displays a set of results corresponding to the application service in a display area in the client system based on the information package, and also sends a user package having the set of results back to the server system. This user package is processed by at least identifying zero or more application services attributable to the word string based on the set of results.

### CROSS REFERENCE TO RELATED APPLICATIONS

This application is a continuation in part of U.S. application Ser. No. 12/136,780 filed on Jun. 11, 2008 and entitled “Method and System for Displaying Extended Information”, which is herein incorporated by reference in its entirety.

### BACKGROUND

The present invention relates generally to Internet technologies, and more particularly to a method for generating extended information in an Internet browser.

The world-wide web has grown exponentially over the past decade. This growth is mainly driven by advances in Internet technologies, many of which are associated with the Internet browser. The Internet browser is a software application which enables an Internet user to view and interact with a web page having a plurality of text, images, rich media content, at a remote location over an Internet network. Some of the most popular Internet browsers are: Microsoft Corporation's Internet Explorer, Mozilla Foundation's Firefox, Apple Inc.'s Safari, Google's Chrome, and Opera Software's Opera Browser. The Internet browser, or simply the browser, typically accesses the remote location through a user agent protocol, most typically the hypertext transfer protocol (HTTP). A browser HTTP request is typically triggered by a user manually submitting a uniform request locator (URL) address in the browser or by a user clicking on a link in a viewing area of the browser. The browser then delivers a plurality of text, images, rich media content, or a combination of the above to the viewing area in which the user can view and interact with the text, images and/or rich media content. With some exceptions, since each new HTTP request returns a new web page, the content of the new HTTP request basically replaces the content of the previous request. When the content length and size of the web page are large, each new HTTP request becomes substantial and cumbersome. When a user wants to look at multiple sets of information, the user typically needs to open multiple windows and/or multiple tabs within the browser.

In Internet's more recent generation, typically termed “Web 2.0”, the browser not only accesses the remote location through HTTP, but makes HTTP connections in the background of a current web page to exchange small amounts of data such that only the information that needs to be refreshed in the current web page is actually reloaded and refreshed. This allows web pages to be refreshed quickly and efficiently. The most common method for facilitating such exchange of small amounts of data is through a group of web development techniques called asynchronous JavaScript and Extensible Markup Language (XML), or AJAX. This group of techniques, well known by those skilled in related art, is designed to interact with and complement each other.

Using AJAX, rapid data exchange is possible. A popular format for such data exchange is JavaScript Object Notation (JSON), a light-weight, human-readable format that represents simple computer data structures and arrays. Using a combination of AJAX and JSON, information can be delivered in real-time to the user wanting that information. For example, various websites have designed browser “pop-ups” wherein when a user places a mouse pointer over a word, a small window pops up in close proximity to the location of the word. This small window may contain extended information related to the word or the text in which the word appears. As an example, if the word is “CSCO”, which is the Nasdaq stock symbol for Cisco Systems, the Bay Area network systems company, a small pop-up window corresponding to the word “CSCO” may include a delayed stock market quotation for Cisco Systems, as well as a plotted graph displaying Cisco's recent price performance.

However, there are a few problems associated with such pop-ups. One problem is that a pop-up window can be very intrusive and annoying to the user. If the user accidentally places the mouse pointer over the word, the small window appears in the viewing area, often covering and blocking some of the web content that the user intends to read. If the user accidentally clicks on any links in the small window, the browser may bring up a new page related to the information displayed in the small window, thereby significantly disrupting the user's browsing experience. Furthermore, although the user may find some pop-up windows in certain sites welcoming while some pop-up windows in other sites intrusive, the user typically has very limited means to control the behavior of these pop-up windows across multiple third-party sites. The user may also want to have more control over the kind of extended information for display. For example, for the word “CSCO”, while someone interested in the financial markets may welcome stock quotation as extended information, a network engineer may be more interested in looking at discounted prices for products made by Cisco Systems rather than stock quotations. Some browser setups even actively seek to block these small windows, thus making the delivery of such pop-up windows problematic.

Desirable in the art of Internet technologies is a more precise method for generating extended information such that the extended information is relevant to the user.

### SUMMARY

In view of the foregoing, the following provides a method for generating extended information in a client system.

In one embodiment, a method for displaying a set of results in a client system comprises first sending an information request having at least a word string to a server system. This word string is to be captured by the client system after a send event. The server system then selects, based on the word string, one or more application services, wherein each of the one or more application services provides a set of results. The server system also ranks the one or more application services by calculating an overall score for each of the one or more application services, and then transmits an information package comprising one or more overall scores corresponding to the one or more application services. Finally, the client system displays a set of results corresponding to the one or more application services in a display area in the client system based on the information package, and also sends a user package back to the server system. This user package is processed by at least identifying zero or more application services attributable to the word string. This user package includes at least a set of results from a search engine provider.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 provides a flow in accordance with one embodiment of the present invention.

FIG. 2 provides a flow elaborating a client system display process in accordance with one embodiment of the present invention.

FIG. 3 provides a flow elaborating the usage of a user package in accordance with one embodiment of the present invention.

### DESCRIPTION

The following will provide a detailed description of a method for generating extended information in a client system. More specifically, the method provides an information discovery mechanism that enables the generation of extended information to be provided to an Internet user using an Internet browser. Reference will now be made to the drawings to describe presently preferred embodiments of the invention. It is to be understood that the drawings are diagrammatic and schematic representations of the presently preferred embodiments, that they are not limiting of the present invention, and that they are not necessarily drawn to scale.

When a user browses the Internet, there are often words or phrases, or keywords, in a web content that the user is interested in knowing more about. As an example, in a web content about the Academy Awards, the author of the web content includes a select list of famous actors and actresses who have won the Academy Awards: George Clooney, Nicole Kidman, Denzel Washington, and Katharine Hepburn. A young user in this example has heard of the names of the first three actors, because they have recently won the award. Katharine Hepburn, though considered to be one of the most prolific actresses in the twentieth century, is not known by the young user. The young user, curious about Hepburn, finds out about the Connecticut-born actress by, as an example, searching her name on Google, or in other similarly situated Internet search engines, or in other film-focused web sites. A modern-day browser usually includes a search box in its interface to enable searching without requiring the user to first load the search engine landing page. Nevertheless, the user will still have to type in the keyword “Katharine Hepburn” in the search box (in the browser or in the search engine landing page), or the user will at least have to copy and paste the keyword into the search box. After the search result appears, the user will have to click on at least one link to retrieve some information about Hepburn. To retrieve information about Hepburn from different sources, the user may need to click through into each source to find extended information, or any additional information related to the keyword.

The present invention provides a mechanism by which extended information is discovered and generated based on the keyword.

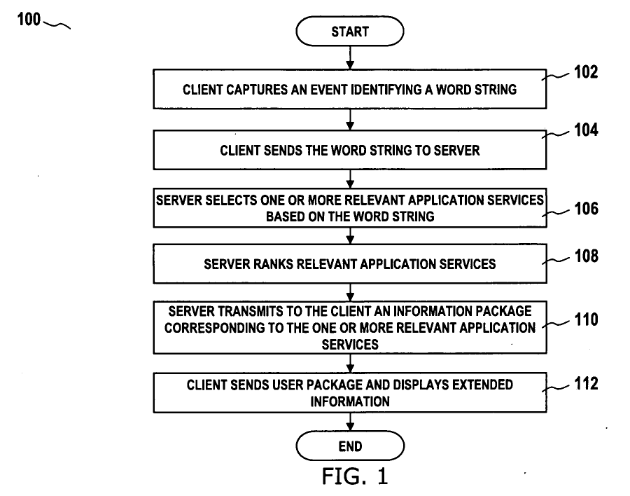

Flow 100 in FIG. 1 provides a method whereby extended information is delivered from a server system to a user of a client system. In one example, the server system is a web server that listens to HTTP requests on the Internet network, and the client system is a web surfing device that is coupled to the Internet network. This web surfing device may be coupled to the Internet network over Ethernet, or over the air via one of the many wireless transport methods, including General Packet Radio Service (GPRS) and 802.11b. In one embodiment, this web surfing device is a browser such as Microsoft Corporation's Internet Explorer, or Mozilla Foundation's Firefox. It is understood by those skilled in the art that some of the functions and methods performed by the client system may be alternatively performed by or delegated to a software addition to the browser. This software addition may be a browser add-on such as a Firefox extension, a Firefox plug-in, or an Internet Explorer plug-in such as an ActiveX object. This software addition is designed to interact with the rest of the client system, and includes at least an ability to capture messaging events generated by the client system and an ability to deliver at least a snippet of displayable HTML code to the client system. In step 102, the client system first captures an event identifying a word string. The event is any event corresponding to the browser or the operating system under which the browser is run. For example, the client system listens to all browser and operating system events corresponding to mouse-pointer actions. When a mouse-pointer action results in a word string being highlighted and selected, the client system identifies the word string. Highlighting refers to the markup of a word string, made feasible by: first clicking, on a mouse button, at one end of the word string; dragging, without releasing the mouse button, towards the other end of the word string; and finally releasing the mouse button. Highlighting may be alternately realized by using a “Find” function in the client system, such as the “Find” function (“Edit” menu, then “Find”) in Firefox. In this example, the matched string will then be highlighted by Firefox. Highlighting of a string of words results in a highlighted text. In an example, this word string is marked and identified by a dark blue background and a light text color in a generic Firefox installation. In another example, the client system listens to an event when the user presses a key, such as “Enter”, or clicks, e.g. using a pointer device, on an element in the browser. This element may be an image, a submit button, a text field, a text area, or another similar HTML element. When this key-pressing or clicking event is captured, the word string is identified at an input area, such as a designated text field or a text area. Specifically, the word string may be directly copied from a value of the input area. In one example, the input area is an “input” element inside a “form” element in a string of HTML code. The value of the input area is thus the value of the “input” element, which may be captured or copied by using JavaScript codes.

The word string is further defined as a string of characters with a non-zero length. Characters may include alphanumeric characters, control characters, special characters, empty spaces, linguistic characters representing international scripts, or otherwise computer readable characters, e.g. ASCII, Unicode, GBK, GB2312, or ISO-8859-1 characters, whose characteristics and definitions are well understood by those skilled in the art. It is further contemplated that the word string may be embodied in or represented by an image, a rich media text, or a non-text rich media.

After the word string is captured by the client system in step 102, the client system sends the word string to the server system in step 104 in an information request through the Internet network. The client system may send the word string to the server system only after a send event. In a preferred embodiment, this send event needs to occur before the word string is sent to the server system. In this preferred embodiment, for example, this send event is a mouse-move event whereby a user drags an HTML element away from its original position by at least five pixels in either of the two dimensions of the viewing area's Cartesian plane. In the preferred embodiment, this HTML element is a highlighted text string, and the HTML element's location is defined by the (x,y) values relative to a corner of the viewing area's Cartesian plane. In another embodiment, this send event occurs when the user drags the highlighted text away from its original position by at least five pixels in both dimensions of the viewing area's Cartesian plane. In one embodiment of the present invention, this information request may be performed through an AJAX request from the client system to the server system. The information request includes the word string, and may further include an identifier for the client system. In a preferred embodiment, the information request is a “GET” AJAX method, whereby the request URL is encoded with at least the word string or its encoded derivative, and, optionally, the identifier for the client system. In this preferred embodiment, the request URL includes the word string “Katharine Hepburn”, or the word string “Katharine%20Hepburn”, in which the additional “%20” refers to the URL encoding for a space. It is understood that other proxies for “%20” may exist (for example, a “#” character), and that these proxies may be applied without deviating from the spirit of the present invention. It is also understood that the word string may be further encoded to facilitate efficient transfer and processing of the word string. For example, the word string may be encoded into a string of ASCII characters, or into a string of HEX characters.

In another embodiment, the information request is a “POST” AJAX method, whereby the word string or its encoded derivative, and, optionally, the identifier for the client system, are embedded in a HTML form, to be sent to the server system in a HTML post. In this embodiment, because the server system may close connection immediately following the receipt of the “POST” data, it is contemplated that the client system will need to re-open a connection to the server system via constant polling, streaming, or a derivative of the above.

It is understood by those skilled in the art that there are other common methods for sending the word string from the client system to the server system, and that some of these methods can be applied to step 104 without deviating from the spirit of the present invention. For example, instead of sending an asynchronous AJAX request to the server system, the client system maintains a pseudo always-on connection with the server system, for example, by using Comet. Alternatively, the client system maintains an always-on connection with the server system through a dedicated port in the client system.

After step 104, the server system in step 106 receives the word string and then selects one or more application services based on the word string. An application service is a supplier of extended information whereby when the application service receives a request, often with some input parameters, such as the word string, the application service returns a set of results. The set of results is associated with the word string, and is equivalent to extended information. For example, if the word string is “Katharine Hepburn”, the set of results, or extended information, may include Hepburn's birthday, place of birth, number of awards won etc. The set of results may be contained in a JSON-compliant or a JSON-like document, in an XML document, or in a formatted HTML document ready to be displayed in a viewing area in the browser.

In a first scenario, only one application service is selected. Further in this first scenario, the only application service selected is a search engine provider that provides a search engine search result. In a preferred embodiment, the preferred search engine provider is Google.

After step 106, flow 100 goes to step 108, wherein the server system ranks the one or more relevant application services based on the word string. In the first scenario, since only one application service is selected, this step will rank the only application service selected as first. Specifically, this step ranks the search engine provider as first (and only). After step 108, the flow goes to step 110, where the server system transmits back to the client system an information package corresponding to one or more application services. In the first scenario, since only one application service is selected, the information package corresponds to the only application service selected. Specifically, the information package includes search engine search result from the search engine provider. In step 112, the client system sends a user package and displays in a display area the set of results given by the application services. The user package includes at least a set of results corresponding to an application service. In the first scenario, only one set of results given by the only application service selected is displayed, while the user package includes at least the search engine search result. The user package may be formatted as an XML document encapsulating the search result. In a preferred embodiment of the present invention, the user package includes a multi-byte string to be sent by the client system and to be received by the server system. This multi-byte string may be JSON-compliant, and may include search engine search results in an array of elements. The array of elements includes at least the URL link for each search result entry of the search result.

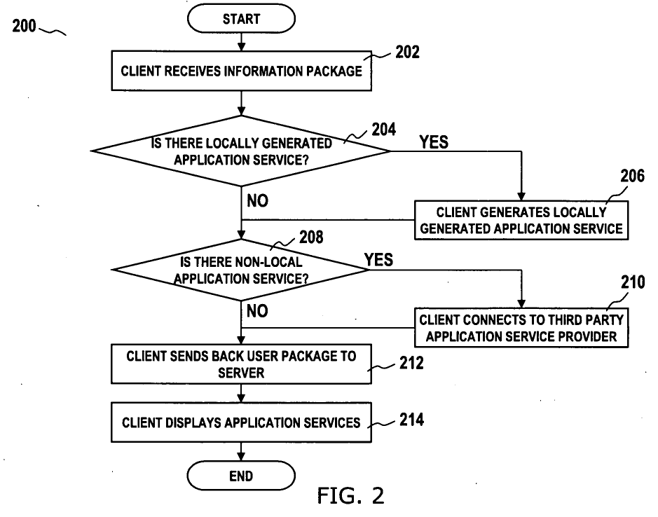

FIG. 2 provides a flow 200 that elaborates upon step 112 in FIG. 1 in accordance with one embodiment of the present invention. Referring to both FIGS. 1 and 2, after step 110, flow 100 goes to step 112, which is further broken down, in one embodiment, in flow 200. The client system receives the information package in step 202. This information package may be an XML document, or a JSON multi-byte string. After step 202, the flow goes to step 204, where it is determined whether or not there are locally generated application services. If there is at least a locally generated application service, the flow goes to step 206, where the client system generates a set of results corresponding to the locally generated application service.

After generating locally generated application service(s), the flow goes to step 208. The flow also goes to step 208 if there is no locally generated application service at step 204. Step 208 determines whether or not there is non-local application service. If there is at least one non-local application service, the flow goes to step 210, where the client system connects to a third party application service provider to request a set of results corresponding to the application service. After the client system receives a set of results from at least an application service from a third party application service provider, the flow goes to step 212 and then to step 214, where at least the set of results from at least one application service is displayed in a display area. This display area may be a browser sidebar, or may be a viewing area of the browser. If there are more than one set of results returned by more than one application service, the client system delivers at least one set of results from at least one application service, and may deliver more than one set of results from multiple application services according to the ranks, as determined by overall scores, given to each application service by the server system. It is noted that the relationship between ranks and relative positions may be modified through user preference. For example, the user may choose to order the relative positions of sets of results according to ascending ranks, descending ranks, or ranks based only on relevancy scores. At step 208, if there is no non-local application service, the flow goes to step 212, where the client system generates the user package and sends the user package to the server system. After step 212, the flow goes to step 214, where the client system displays zero or more sets of results from zero or more application services.

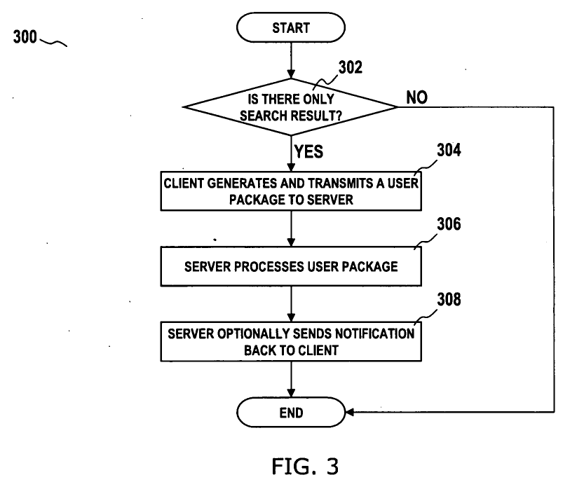

FIG. 3 provides a flow 300 that elaborates upon step 212 in FIG. 2 in accordance with one embodiment of the present invention. Referring to both FIGS. 2 and 3, after step 208 or step 210, flow 200 goes to step 212, which is further broken down, in one embodiment, in flow 300. In step 302, the client system determines whether or not search result is the only set of results available. In other words, the client system determines both whether there is only one application service selected and whether the only one application service selected is a search engine provider. If the answer is no, the flow ends. If the answer is yes, the flow goes to step 304, where the client system generates the user package. In one example, the client system generates the user package by retrieving the search engine search result provided by the search engine provider and then by packaging this search engine search result into the user package. This user package may be an XML document, a JSON multi-byte string, or any other similarly functioning object documentation format well known by those skilled in the art. The user package is then transmitted by the client system to the server system, for example, by making an AJAX request. The flow then goes to step 306, where the server system processes the user package. In one example, the server system processes the user package by first retrieving each of the URL links corresponding to each of the search result entries. The server system then matches the domain name in each URL link with a predetermined application service database. Referring to both FIGS. 1 and 3, for example, a user searches for “Marion Cotillard”, a recent Academy Award winner. Assume, at the moment that the word string is not currently affiliated with any application service, the step 106 selects only one application service, which is a search engine provider. The step 302 then determines a “yes” and flow 300 goes to step 304, where the search engine search result is incorporated into the user package and the user package is sent to the server system. Flow 300 then goes to step 306, where the user package is processed by at least identifying zero or more application services attributable to the word string based on the information available in the user package.

In an example, the information available in the user package is a search engine search result, which includes one entry with the following URL link: http://en.wikipedia.org/wiki/Marion_Cotillard, which is a page in Wikipedia's domain, i.e. wikipedia.org. If Wikipedia is also an application service affiliated with the server system, the server system then predicts that, based on the search engine search result and subsequently the domain match, the word string “Marion Cotillard” may have an entry at and should be affiliated with Wikipedia. The server system then, as part of the prediction mechanism, relates the word string “Marion Cotillard” with the Wikipedia application service and stores that relationship in a server database, as an example, in a keyword table. Now, the word string “Marion Cotillard” is affiliated with the Wikipedia application service. A corresponding category identifier is related to the Wikipedia application service in a relevancy scoring table. The relevancy score in the relevancy scoring table may be pre-populated at this point, e.g. 0.50 for an appearance in an entry in the search engine search result, or a higher relevancy score if the Wikipedia entry in the search engine search result is ranked high by the search engine provider. In a preferred embodiment, the relevancy score is linearly related to the rank at which the application service match (i.e. a URL link under the Wikipedia domain) appears in the search engine search result. After step 306, flow 300 goes to step 308, where a notification is optionally sent back to the client system. For example, if the server system determines that “Marion Cotillard” may have an entry on Wikipedia, the server system sends a notification back to the client system, indicating that there is now an application service, i.e. the Wikipedia application service, in addition to the search engine provider, that may provide extended information about the word string “Marion Cotillard” to the user. In an embodiment, this notification is a text string that pops up in an area within the browser as “New content found. Click now for more”. When the user clicks on the notification, the client system restarts flow 100, with the word string “Marion Cotillard”. When flow 100 is restarted, because “Marion Cotillard” is freshly affiliated with the Wikipedia application service, step 106 selects at least the Wikipedia application service and step 112 displays the set of results provided by the Wikipedia application service as extended information in the browser.

It is contemplated that step 308 may be modified such that instead of sending a notification back to the client system, the server system sends a modified information package to the client system that includes the newly affiliated application service as an application service available for the word string. That way, when flow 200 goes from step 212 to step 214, the client system is able to display a set of results provided by the newly affiliated application service, in addition to search engine search result. For example, in the first scenario, extended information includes not only the search engine search result, but also a set of results provided by the Wikipedia application service. As such, the system “learns” word string affiliations with application service by utilizing the search engine search result provided by the search engine provider.

It is contemplated that the server system may optionally include a verification system whereby such relationships are periodically reviewed and rescinded if the relationship turns out to be incorrect or outdated. Furthermore, it is contemplated that step 302 may be removed from flow 300 such that flow 300 starts by going directly to step 304, whereupon a user package is always generated by the client system and sent to the server system whenever there is at least search result amongst the extended information generated at step 214 after step 208 or step 210 in FIG. 2.

The server system may further process the user package by matching not merely the domain name in each URL link with a predetermined application service database, but also a set of rules governing such matches. For example, in order to match any given word string with the Wikipedia application service, at least part of (or all tokens in) the word string has to appear in the URL link of corresponding to a search result entry. For example, the Wikipedia URL link for “Marion Cotillard” may be required to include at least “Marion” or “Cotillard” for partial matching, or “Marion” and “Cotillard” for all-text matching, or “Marion Cotillard” for full-phrase matching. The server system may also process the user package using fuzzy logic. For example, the word string “Cesar Award for Best Actress” may be attributable to the URL link http://en.wikipedia.org/wiki/César_Award_for_Best_Actress even though the French accented character “é” is not matching with the incorrectly typed “e”. In another example, fuzzy matching may allow misspelling of the word string, e.g. “Caesar Award for Best Actress” may still be attributable to the URL link http://en.wikipedia.org/wiki/César_Award_for_Best_Actress even though there is a misspelling for the word César. It is contemplated that other fuzzy logic techniques well known in the art may be applied herein, whereby the word string still matches, by partial pattern, with the URL link even though the match may not be perfectly exact.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for displaying a set of results in a client system comprising:
sending an information request having at least a word string, the word string to be captured by the client system after a send event, to a server system;
selecting, based on the word string, one or more application services, each of the one or more application services for providing a set of results;
ranking the one or more application services by calculating an overall score for each of the one or more application services;
transmitting an information package comprising one or more overall scores corresponding to the one or more application services; and
sending a user package and displaying a set of results corresponding to the one or more application services in a display area in the client system based on the information package.

2. The method of claim 1, wherein sending the user package comprises:
determining both if only one application service is selected and if the only one application service selected is a search engine provider;
generating and transmitting a user package by the client system to the server system; and
processing the user package by at least identifying zero or more application services attributable to the word string, wherein the user package includes at least a set of results from a search engine provider.

3. The method of claim 2, wherein identifying zero or more application services attributable to the word string includes at least predicting a relationship between the word string and an application service, and storing the said relationship in a server database.

4. The method of claim 3, wherein the server database includes a keyword table and a relevancy scoring table.

5. The method of claim 3, wherein storing the said relationship in a server database includes pre-populating the server database with a relevancy score.

6. The method of claim 2, wherein sending the user package further comprises sending a notification to the client system.

7. The method of claim 1, wherein the client system includes a software addition.

8. The method of claim 1, wherein the send event includes at least a mouse-move event whereby an HTML element is dragged away from the HTML element's original position by at least five pixels in both dimensions of a Cartesian plane.

9. The method of claim 8, wherein the HTML element is a highlighted text.

10. The method of claim 1, wherein the send event includes at least a key-press event or a mouse-pointer event, upon which the word string is captured from an input area.

11. The method of claim 1, wherein the word string is a string of computer readable characters having a non-zero length.

12. The method of claim 1, wherein the word string is embodied in or represented by an image, a rich media text, or a non-text rich media.
